(19) United States
(12) Patent Application Publication
(10) Pub. No.: US 2011/0041168 A1
(43) Pub. Date: Feb. 17, 2011

(54) SYSTEMS AND METHODS FOR TARGETING ONLINE ADVERTISEMENTS USING DATA DERIVED FROM SOCIAL NETWORKS

(76) Inventors: Alan Murray, Weston, VT (US); Joshua Abram, New York, NY (US); Rodney Hook, New York, NY (US); Balaji Devarajan, Edison, NJ (US)

Correspondence Address: Byrne Poh LLP, 11 Broadway, Ste 865, New York, NY, 10004, US

(21) Appl. No.: 12/191,412

(22) Filed: Aug. 14, 2008

Related U.S. Application Data
(60) Provisional application No. 60/964,669, filed on Aug. 14, 2007.

(51) Int. Cl. H04L 9/32

(52) U.S. Cl. 726/7

(57) ABSTRACT

Systems and methods for targeting online advertisements using data derived from social networks are provided. In accordance with some embodiments, the method comprises: presenting a user at a user computer with a publicly accessible website that includes user-generated social networking content over the Internet, wherein the user is authorized to access features and the user-generated social networking content associated with the publicly accessible website upon inputting user information; in response to receiving user information from the user, displaying a webpage associated with the user; displaying at least one advertisement on the webpage, wherein the at least one advertisement embeds an object in the user computer and wherein the object is used to obtain a unique identifier associated with the user; using the object to construct a micronetwork of the members associated with the user, wherein the object obtains the unique identifier from each member that visits the webpage and the unique identifier from each member that establishes a relationship with the user; using the object to monitor information relating to the user, wherein the information includes actions executed by the user; retargeting advertisements for transmission to the user and the micronetwork based on information monitored by the object; and transmitting at least one retargeted advertisement to the user and the micronetwork associated with the user, wherein the at least one retargeted advertisement is transmitted using the unique identifier associated with the user and the unique identifier associated with each member of the micronetwork.

### CROSS-REFERENCE TO RELATED APPLICATIONS

This application claims the benefit of U.S. Provisional Patent Application No. 60/964,669, filed on Aug. 14, 2007, which is hereby incorporated by reference herein in its entirety.

### FIELD OF THE INVENTION

The present invention generally relates to systems and methods for targeting advertisements to users based on data derived from social networking websites. More particularly, the present invention relates to using data endemic to social networking websites to more efficiently present advertisements and other content to users across the Internet.

### BACKGROUND OF THE INVENTION

Social networking websites, such as MySpace, Friendster, Facebook, and Linkedin, have grown enormously over the past few years. It has been generally reported by industry analysts that as much as forty percent of a consumer's time on the Internet is spent surfing social networking webpages and/or webpages generally characterized by the core content having been created by other consumers rather than employees of the website being visited. A member of a social networking website establishes an account and creates relationships with other accounts, thereby connecting the members in a network. When a member connects with other members by proffering or accepting invitations to link their pages, those members are broadcasting their own social network. In addition to generating these links of association, members of these social network websites provide descriptive personal profiles that include their likes, their dislikes, demographic information, etc. These personal profiles and links to other members create a social network.

The traditional methods for targeting online advertisements generally presupposed that the consumer's visit to a given website(s) revealed his or her interest and therefore the kinds of advertisements that they should be shown. For example, visitors to “www.flyfishing.com” could be assumed to be interested in equipment, clothing and books known to be of interest to fishing enthusiasts. The first generation of Internet advertising companies spent an enormous amount of time and energy creating taxonomies that mapped individual web sites such as www.flyfishing.com with categories known to be of interest to advertisers such as travel, sports, education, etc. Many companies, such as Doubleclick Inc., placed “cookies” on the computers of consumers and used these cookies to target advertisements to consumers based on the interest(s) that had been evidenced by a consumers visits to a catalogued site.

For a time, this system provided a more efficient way to target consumers for advertisers. Especially in the early years of the Internet when consumers spent the vast majority of their time viewing content produced by the employees of major portals, such as Yahoo! or AOL (formerly America Online, Inc.), it was easy for the creators of advertising technology to state with confidence that a visitor to AOL's “small business” section was a current or would-be entrepreneur who would respond at high rates to advertisements for products, such as franchising opportunities and small business credit cards. However, as consumers began spending an ever increasing percentage of their time on the Internet at social networking websites (and other websites having user-generated content) that defy easy categorization, marketers are increasingly challenged to discern which advertisements can most profitably be shown to which consumers. Whereas in the past, online advertising companies could package consumers for sale to advertisers based on what websites (e.g., sports, travel, beauty, small business, etc.) those consumers visited. It has been currently reported that twenty percent of online consumer page views can be readily catalogued in this manner and that as much as eighty percent of all Internet page views occur on social networking, user generated content and other pages that defy ready characterization into an existing Internet advertising interest segment.

This problem in matching advertisements and consumers has become more acute as the exploding popularity of social networking sites has increased the number of advertisement impressions seen at these sites. It has been reported that social networking websites, such as MySpace, display over one billion advertisements per day. However, a majority of these displayed advertisements are often disregarded by consumers or members of the social networking websites. Even though these social networking websites possess an enormous amount of information on each member and present a number of advertisements per day, advertisers and social networking websites have done little to leverage this wealth of information.

Thus, it would be desirable to provide an advertisement application that leverages the rich, but unused data available from social networking webpages.

### SUMMARY OF THE INVENTION

In accordance with the present invention, systems and methods for facilitating the transmission of advertisements to users are provided.

Generally speaking, the application uses data endemic to social networking websites (e.g., relationship information and visitation information) to provide advertisements and other suitable content to the user of a social network website and the members of the user's micronetwork or micro-affinity group.

It should be noted that the application uses relationship information, visitation information, and/or any other suitable information to create micronetworks or micro-affinity groups. Advertisements and/or other suitable content are provided to these micronetworks or micro-affinity groups. The application does not group the user and some members of the micronetwork based on common attributes (e.g., members in the same zip code, members having the same age, etc.).

It should also be noted that the application generally does not analyze user profiles on social networking websites or obtain attribute data on a particular user or users in order to provide advertisements or media content to that particular user. This may, for example, protect the privacy of users. More particularly, the application generally does not associate data obtained from a user of a social networking website with that particular user. For example, in response to a user selecting an advertisement on the social networking website relating to hybrid automobiles, the application may determine whether to transmit that advertisement (or similar advertisements) to one or more of the members within the user's micronetwork or micro-affinity group. In another example, in response to a user visiting a website relating to hybrid automobiles, the application may determine whether to transmit that advertisement (or similar advertisements) to one or more members of the social networking website that the user has visited. In yet another example, in response to a user visiting a website relating to hybrid automobiles, the application may associate advertisements relating to hybrid automobiles with the micronetwork or micronetworks of which the user is a member. In yet another example, application does not store information (e.g., name, email address, etc.) such that it can be linked to an individual user.

Even further, in response to a member visiting the social networking page associated with the user, the application associates the member with the user's micronetwork or micro-affinity group. The associations between the user and one or more micronetworks or micro-affinity groups are not transparent to the user. For example, in order to protect the privacy of users, the application generally does not reveal to the user, members of the user's micronetworks or micro-affinity groups, and/or members of the social networking website the different micronetworks associated with each of them. In another example, by creating micronetworks or micro-affinity groups, the application does not collect any private information relating to the user or the members of the social networking website. The application creates micronetworks and provides media (e.g., advertisements, content, etc.) to members of those micronetworks.

In some embodiments, the interactive advertisement application presents a user at a user computer with a publicly accessible website that includes user-generated social networking content over the Internet. The user is authorized to access features and receive the user-generated social networking content associated with the publicly accessible website upon inputting user information. In response to receiving user information from the user, the application displays a webpage associated with the user.

At least one advertisement is displayed on the webpage, where the at least one advertisement embeds an object (e.g., a cookie, a web bug, etc.) in the user computer. The object is used to obtain a unique identifier associated with the user. The object is also used to construct a micronetwork of the members associated with the user, where the object obtains the unique identifier from each member that visits the webpage and the unique identifier from each member that establishes a relationship with the user. In addition, the object monitors information relating to the user (e.g., actions executed by the user). Based on the information monitored by the object, the application retargets advertisements for transmission to the user and the micronetwork associated with the user.

The application transmits at least one retargeted advertisement to the user and the micronetwork associated with the user, where the at least one retargeted advertisement is transmitted using the unique identifier associated with the user and the unique identifier associated with each member of the micronetwork.

Thus, there has been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and description matter in which there is illustrated preferred embodiments of the invention.

### BRIEF DESCRIPTION OF THE DRAWINGS

Various objects, features, and advantages of the present invention can be more fully appreciated with reference to the following detailed description of the invention when considered in connection with the following drawing, in which like reference numerals identify like elements.

FIG. 1 is a simplified flowchart illustrating the transmission of advertisements to the user and one or more members of the social networking website using an embedded object in accordance with some embodiments of the present invention.

FIG. 2 is an illustrative diagram showing micronetworks or micro-affinity groups that may be generated in accordance with some embodiments of the present invention.

FIG. 3 is a simplified flowchart illustrating the transmission of advertisements to the user and one or more members of the social networking website based on a monitored response rate in accordance with some embodiments of the present invention.

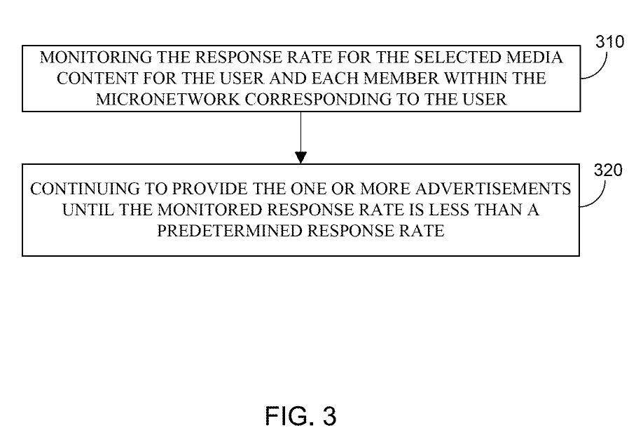

FIG. 4 is a schematic diagram of an illustrative system on which an interactive advertising application may be implemented in accordance with some embodiments of the present invention.

FIG. 5 is a schematic diagram of an illustrative user computer and server as provided, for example, in FIG. 4 in accordance with some embodiments of the present invention.

### DETAILED DESCRIPTION OF THE INVENTION

In accordance with the present invention, an interactive advertising application (sometimes referred to herein as “the application”) is provided. The application uses data (e.g., relationship data, visitation data, e-commerce activity data, etc.) from social network websites or other sources of user-generated content to target advertisements (e.g., a static advertisement, a rotating advertisement, a video advertisement, an audio advertisement, etc.) or any other suitable media content to users.

Generally speaking, the application uses relationship information and visitation information to provide advertisements to the user of a social network website and the members of the user's micronetwork or micro-affinity group. It should be noted that, in some embodiments, the advertisements may be provided to the user of the social networking website and a particular degree of the user's micronetwork (e.g., the first degree micronetwork, the second degree micronetwork, etc.).

As used herein, a “micronetwork” (sometimes referred to herein as a “micro-affinity group”) generally includes a subset of users who, through their behavior as evidenced on social networking websites, are more likely to share interests and consumer preferences. For example, a micronetwork may include members with a user's social network that share a particular interest. In another example, a micronetwork may include users that have visited the user's page on the social networking website.

It should be noted that the application uses relationship information, visitation information, and/or any other suitable information to create micronetworks or micro-affinity groups. Advertisements and/or other suitable content are provided to these micronetworks or micro-affinity groups. The application does not group the user and some members of the micronetwork based on common attributes (e.g., members in the same zip code, members having the same age, etc.).

It should also be noted that the application generally does not analyze user profiles on social networking websites or obtain attribute data on a particular user or users in order to provide advertisements or media content to that particular user. This may, for example, protect the privacy of users. More particularly, the application generally does not associate data obtained from a user of a social networking website with that particular user. For example, in response to a user selecting an advertisement on the social networking website relating to hybrid automobiles, the application may determine whether to transmit that advertisement (or similar advertisements) to one or more of the members within the user's micronetwork or micro-affinity group. In another example, in response to a user visiting a website relating to hybrid automobiles, the application may determine whether to transmit that advertisement (or similar advertisements) to one or more members of the social networking website that the user has visited. In yet another example, in response to a user visiting a website relating to hybrid automobiles, the application may associate advertisements relating to hybrid automobiles with the micronetwork or micronetworks of which the user is a member. In yet another example, application does not store information (e.g., name, email address, etc.) such that it can be linked to an individual user.

Even further, in response to a member visiting the social networking page associated with the user, the application associates the member with the user's micronetwork or micro-affinity group. The associations between the user and one or more micronetworks or micro-affinity groups are not transparent to the user. For example, in order to protect the privacy of users, the application generally does not reveal to the user, members of the user's micronetworks or micro-affinity groups, and/or members of the social networking website the different micronetworks associated with each of them. In another example, by creating micronetworks or micro-affinity groups, the application does not collect any private information relating to the user or the members of the social networking website. The application creates micronetworks and provides media (e.g., advertisements, content, etc.) to members of those micronetworks.

In some embodiments, the application may use data, such as relationship and visitation data, which includes information from other users within the user's social network, to create a micronetwork or micro-affinity group of members. The micronetwork may be, for example, based on the visitation data of a user's page on a social networking website (e.g., the members that visit the user's page, the number of times a member visits the user's page, the number of times a member selects an advertisements while visiting the user's page, the period of time or frequency that a member is visited, etc.), the visitation data in relation to whom a user visits (e.g., the member's page that the user visits, the number of times the user visits another member's page), etc. In another example, the micronetwork may be based on relationship data of a user's page on a social networking website.

In accordance with the present invention, a user of a social networking website, such as MySpace, Friendster, or Facebook, is presented with an advertisement while accessing the pages of the social networking website. The advertisement allows a cookie (sometimes referred to as a “web bug” or “pixel tag”) to be embedded in the user's computer. The cookie monitors and records the user's actions—e.g., visits to other member's social networking webpages, visits to other websites, visits to the user's social networking webpage by other members (using a friendID or other identifier embedded in the URL), etc. Based on this monitored information from the cookie, the application creates a micronetwork of members.

The user's first degree micronetwork may include, for example, the members that visit the user's page and the members that the user visits. Similarly, the user's second degree micronetwork may include the members of the first degree micronetwork associated with each member of the user's first degree micronetwork. For example, if user_zero visits ten members of the social networking website with a high degree of frequency and those ten members each visit ten other members frequently, user_zero's first degree micronetwork includes the ten members frequently visited by user_zero and user_zero's second degree micronetwork includes one hundred members or each member's first degree micronetwork of the user_zero's first degree micronetwork.

As used herein, the application may use cookies or web bugs that are embedded in a web page to monitor the activity of the user at a social networking website or on other websites. For example, the application may generate cookies when a web browser operating on the user's computer views an advertisement on a social networking website. In some embodiments, a cookie may be one or more text files that contain a string of alphanumeric characters. In some embodiments, cookies may be pieces of data that are unable to perform any operation by themselves. Alternatively, each cookie may be a graphic (e.g., a 1×1 pixel GIF image, a web beacon, a tracking bug, a pixel tag, a clear gif, etc.) on a webpage that is designed to monitor who is reading the webpage and the user's activity on the webpage.

It should be noted that the cookie or web bug is generally transparent to the user. When a web browser is used by the user to view the social networking website, the web browser transmits a request to a server to deliver or download content from one or more servers. The request generally includes, for example, the IP address of the user's computer, the time the content was requested, the type of web browser that made the request (e.g., Microsoft Internet Explorer, Netscape Navigator, Mozilla Firefox, etc.), and the existence of cookies previously set by the server. The server may store this information and associate it with a unique identifier.

Alternatively, micronetworks may also be created by placing tracking beacons in high volumes of advertisements flows. These tracking beacons record content into a database, such as the URLs of the content pages that the user views. Using neural networks or other approaches for analyzing the data stored in the database, the user may be assigned to a particular micronetwork. In yet another embodiment, micronetworks may be created by using traffic logs maintained by large user-generated content websites. These traffic logs may be used to clusters users into micronetworks.

It should be noted that, in some embodiments, third party advertisement servers may access visitation data captured by these cookies or web bugs. For example, when browsing a website, the browser sends a request to a web server that includes the IP address of the user's computer, the time the content was requested, the type of web browser that made the request, and the existence of cookies previously set by the server. The server may store this information and associate it with a unique identifier. The information collected using the cookie may be transmitted to a third party advertisement server. In some embodiments, the cookie may be associated with a particular third party advertisement server. For example, the server may place multiple cookies on a user's computer, where each cookie corresponds to a particular third party advertisement server. The collected data is transmitted to each third party advertisement server.

In addition to creating a micronetwork, the application uses the cookie to monitor the websites and web pages visited by the user outside of or external to the social networking website. For example, in response to the user visiting a particular website, such as Orbitz.com, the cookie communicates to the application that the user is visiting a travel website. In response, the cookie may inform the application that the user has visited a travel website and the application may provide the user and members in the user's micronetwork with travel-related advertisements. Alternatively, the cookie may transmit such information to an advertisement server. The advertisement server may then transmit a travel-related advertisement that is provided to the first degree micronetwork and second degree micronetwork on the social networking website. Again, the second degree micronetwork or second degree orbit may include the members of the first degree micronetwork associated with each member of the user's first degree micronetwork. For example, person 0's micronetwork has seven people (persons 1 through 7) and each person has seven members in their associated micronetwork. Then, the second degree micronetwork or orbit has forty-nine additional members (persons 8 through 56).

These advertisements may be served to the micronetworks until a given response rate is no longer attained.

Again, it should be noted that the application uses relationship data, visitation data, and/or other suitable data to create micronetworks. The application does not group the user and members of the social networking website based on common attributes (e.g., members in the same zip code, members having the same age, etc.). The application does not analyze user profiles on social networking websites or obtain attribute data on a particular user or users in order to provide advertisements or media content to that particular user. This may, for example, protect the privacy of users. Accordingly, the application generally does not associate private data obtained from a user of a social networking website with that particular user.

As the application does not collect private information relating to the user or the members of the social networking website, the application does not communicate private information (e.g., information acquired by monitoring the user or particular social networking members) to the user or members in the micronetwork associated with the user. The application does not serve or provide advertisements to each member based on individual needs. For example, the application does not provide fly fishing advertisements in response to the embedded web bug monitoring that the user has accessed a fly fishing website. Instead, the application determines that one or more members in the micronetwork have accessed a website relating to Caribbean cruises and transmits a targeted advertisement to at least a portion of the micronetwork.

In response to a member visiting the social networking page associated with the user, the application associates the member with the user's micronetwork or micro-affinity group. The associations between the user and one or more micronetworks or micro-affinity groups are not transparent to the user. For example, in order to protect the privacy of users, the application generally does not reveal to the user, members of the user's micronetworks or micro-affinity groups, and/or members of the social networking website the different micronetworks associated with each of them. In another example, by creating micronetworks or micro-affinity groups, the application does not collect any private information relating to the user or the members of the social networking website. The application creates micronetworks and provides media (e.g., advertisements, content, etc.) to members of those micronetworks.

It should also be noted that, as these advertisements are served to particular micronetworks, additional web bugs and new web bugs are placed and new relationship and visitation data is received, which is continually used by the application to update the micronetworks and the advertisements that are served to the micronetworks.

It should also be noted that, in some embodiments, the application may extract URL links to other member pages listed as friends from the user's page on the social networking website. For example, the application may extract and store URL links to other pages (containing their associated user profiles and user information).

The following figures and their accompanying descriptions provide detailed examples of the implementation of the systems and methods of the present invention.

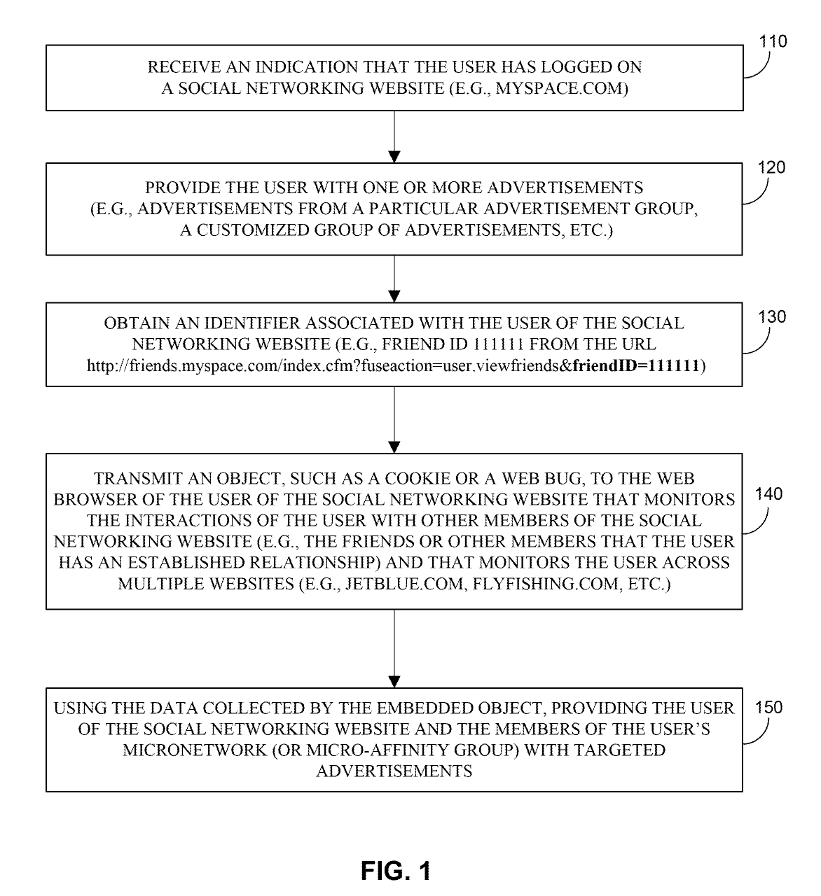

As shown in FIG. 1, the application may receive an indication that the user has logged into a social networking website (e.g., myspace.com, facebook.com, etc.) (step 10). For example, the application may receive a notification from the server running the social networking website that the user has logged into the social networking website. In another example, the application may receive a request from the server running the social networking website that the user has logged into the social networking website and requests that one or more advertisements be transmitted to the server for providing to the user. In response, the application may provide the server of the social networking website or may directly provide the web browser of the user with one or more advertisements (e.g., targeted advertisements from a particular advertisement group) (step 120).

The application may obtain an identifier associated with the user of the social networking website (step 130). For example, in response to receiving a request from the server running the social networking website for advertisements, the application may obtain a unique identifier from the request or from the web browser of the user. The unique identifier may be embedded in the URL of the page. For example, the application obtains friend identifier “111111” from the URL http://friends.myspace.com/index.cfm?fuseaction=user.viewfriends&friendID=111111. In another example, the friend identifier “111111” may be retrieved from the request sent by the web browser of the user.

Along with the one or more advertisements for the user, the application may transmit an object, such as a web bug or a cookie, to the web browser of the user of the social networking website (step 140). The object may, for example, monitor the interactions of the user with other members of the social networking website (e.g., the friends or other members that the user has an established relationship, the members that visit the user's page on the social networking website, the members that the user frequently visits, etc.). For example, the object may record the members' pages that the user frequently accesses and the members that frequently access the user's page. The object may be associated with the friend identifier, where the friend identifier acts as a unique tracking token. The server may also store any information obtained on the user (e.g., the members of the social networking websites that the user interacts with, the pages visited, the pages of other websites visited by the user, the unique identifiers associated with the members of the social networking website that the user interacts with, etc.) to create and dynamically update the user's micronetworks.

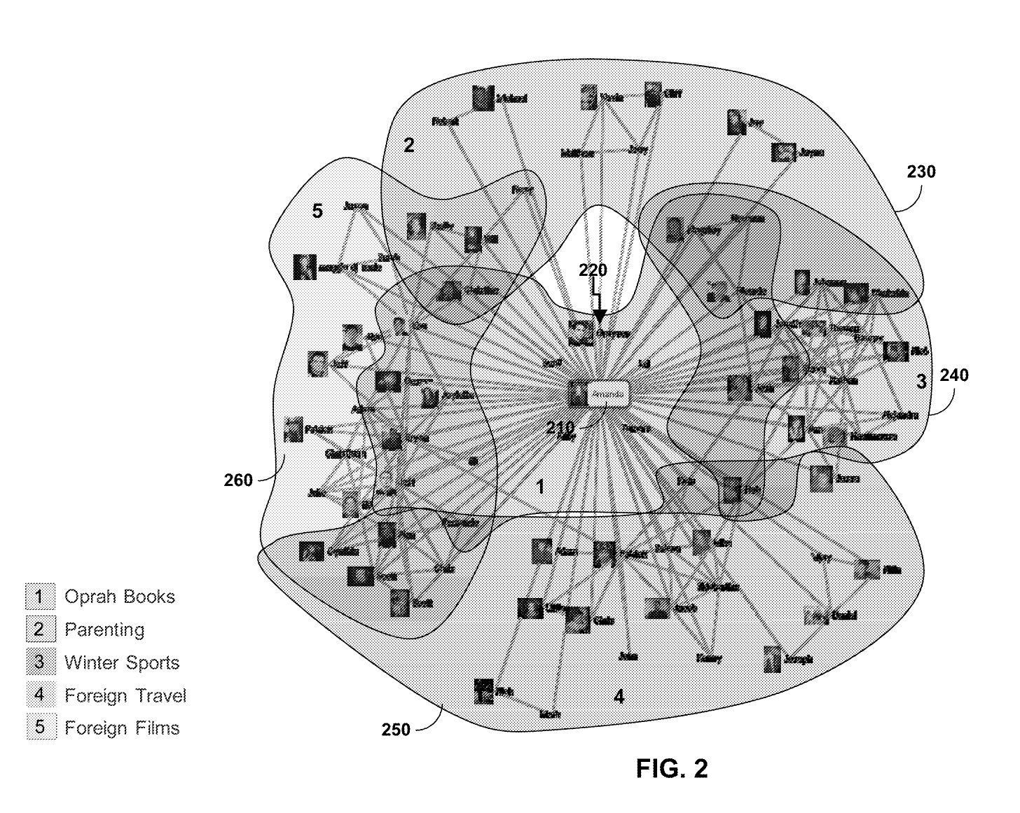

As shown in FIG. 2, the object and the friend identifier may be used to determine the user's micronetworks. For example, a micronetwork may include members with a user's social network that share a particular interest (e.g., a “foreign travel” micronetwork 250 and a “foreign films” micronetwork 260 for user “Amanda” 210). Each user in the “foreign travel” micronetwork may have visited the “foreign travel” page or links on the webpage of user “Amanda.” In another example, a micronetwork may include users that have visited the user's page on the social networking website. In yet another example, the micronetwork may be, for example, based on the visitation data of a user's page on a social networking website (e.g., the members that visit the user's page, the number of times a member visits the user's page, the number of times a member selects an advertisements while visiting the user's page, the period of time or frequency that a member is visited, etc.), the visitation data in relation to whom a user visits (e.g., the member's page that the user visits, the number of times the user visits another member's page), etc. In another example, the micronetwork may be based on relationship data of a user's page on a social networking website.

In some embodiments, the object may also monitor the user's activity across multiple websites. For example, the object may record page requests from the user (e.g., jetblue.com, flyfishing.com, etc.). In another example, the object may record the amount of time the user spends on a website (e.g., 2 minutes on friendster.com, 15 minutes on cnn.com, etc.).

Referring back to FIG. 1, the application may use the collected data from the embedded object to provide the user of the social networking website and the user's micronetwork with targeted advertisements (step 150). For example, in response to the embedded object indicating that the user of the social networking website has frequently visited three members, the application may provide the user and those three members (the user's micronetwork) with the same set of advertisements. The set of advertisements may be targeted to relate to subject matter of one of the websites that the user has visited according to the embedded object.

As described previously, it should be noted that the application does not communicate private information (e.g., information acquired by monitoring the user or the user's micronetwork) to the user or members in the micronetwork associated with the user. The application does not serve or provide advertisements to each member based on individual needs. Rather, the application determines that one or more members in the micronetwork have accessed a website relating to Caribbean cruises and transmits one or more targeted advertisement to the user and at least a portion of the micronetwork associated with the user.

Alternatively, the application may transmit the collected data from the embedded object to one or more third party advertisement servers. Each third party advertisement server may provide the user of the social networking website and the user's micronetwork with targeted advertisements. In some embodiments, the application may analyze the collected data from the embedded object and request that the third party advertisement server transmit particular targeted advertisements. In other embodiments, the application may transmit the collected data for analysis by the third party advertisement server.

In some embodiments, the application may retarget the one or more advertisements that are transmitted to the user and the recently interacted members. For example, the set of advertisements may be automatically updated to relate to the subject matter of one or more websites that the user has recently visited.

In some embodiments, the application may monitor the behavior of the user and the members within the user's social network to gauge the effectiveness of the selected advertisements.

The application may provide the user of the social network and one or more of the micronetwork corresponding to the user with one or more advertisements. As described in FIG. 1, the application may provide the user and members of the user's micronetwork with a set of advertisements. In another example, the application may provide the user and the user's first degree micronetwork and second degree micronetwork with a set of advertisements.

In another example, using the embedded object, the embedded object may monitor the interactions of the user of the social networking website with one or more websites (e.g., flyfishing.com). In response, the application may determine that the user is interested in particular topics, such as fishing, fly fishing, fishing trips, fishing equipment, etc. The application may send advertisements relating to one or more of the topics to the user and one or more members of the user's micronetwork.

The application may monitor the interactions of the user and the member within the user's micronetwork with the selected advertisements (step 310). Based on monitoring the interactions, the application may determine the number of members interacting with each of the advertisements. In some embodiments, each advertisements may have specific requirements attached to the advertisement (e.g., advertisement A is shown until less than 25% of members click on the advertisement, advertisement B is shown until less than 10% of members scroll over the advertisement, etc.). Advertisements that are not selected are less likely to be selected for display to the user and the members within the user's social network, while advertisements that have a high click through rate are more likely to be selected for display.

The application may continue to provide the user and one or more members of the user's micronetwork with the selected advertisements until the monitored response rate is less than a predetermined response rate (step 320). For example, the application may continue to provide the advertisements to the micronetwork until a particular lift over average is no longer achieved.

In some embodiments, the application may use feedback information from the user of the social network website and the members of the micronetwork to determine the advertisements to deliver to the user's micronetwork. For example, the application may provide the user with ten advertisements while the user accesses different webpages on the social networking website. The application monitors the user's interactions with the advertisements (e.g., plays with a gaming application associated with the advertisement, clicks on the advertisement, scrolls over the advertisement, watches the media content associated with the advertisement, etc.). Based on monitoring the user's interactions with the advertisements, the application may provide one or more of the same advertisements to the user's first degree micronetwork and/or second degree micronetwork. For example, the application determines that the user clicks on an advertisement directed to fly fishing. In response to the user selecting that advertisement, the same advertisement directed to fly fishing may be provided to the user's first degree micronetwork. Alternatively, multiple advertisements directed to fly fishing may be provided to the user and the user's first degree micronetwork.

In some embodiments, the application may use feedback information from the user of the social network website to determine the advertisements to deliver to the user as the user uses the Internet. The embedded object (e.g., a cookie) along with the visitation data allows the application to provide relevant advertisements through the websites the user visits based on the actions of the user or the user's micronetwork while using the Internet. The application monitors the user's interactions with the advertisements (e.g., plays with a gaming application associated with the advertisement, clicks on the advertisement, scrolls over the advertisement, watches the media content associated with the advertisement, etc.). Based on monitoring the user's interactions with the advertisements, the application may provide one or more of the same advertisements to the user's first degree micronetwork and/or second degree micronetwork while those users are accessing websites on the Internet. For example, the application determines that the user clicks on an advertisement directed to fly fishing. In response to the user selecting that advertisement, the same advertisement directed to fly fishing may be provided to the user's first degree micronetwork while the members of that first degree micronetwork are accessing one or more websites (e.g., Google.com, NYTimes.com, etc.) on the Internet.

Alternatively, the application may monitor advertisements on one or more websites, receive information from one or more third party advertisement networks or advertisement servers, and/or receive information from one or more web servers. For example, when the user visits the webpage of a merchant (e.g., Orvis), the webpage may include pixel tags from third party advertisement networks (e.g., advertisement servers that are affiliated with the webpage). These pixel tags or other embedded objects record that the user's computer has visited the merchant's webpage and provide other information to the advertisement server (e.g., the particular page accessed by the user, the amount of time spent on a particular page, information on the user's computer, information from the user's web browser, etc.). Using the information from the advertisement server, the application may provide or instruct the advertisement server to provide the user and the members within the user's micronetwork with advertisements on other webpages to bring the user and the members back to the merchant's website. Alternatively, the application may use the information from the advertisement server to provide the user and the members within the user's micronetwork with advertisements relating to the subject matter of the merchant's website.

In some embodiments, the application may monitor the behavior of the user and the members within the user's social network to gauge the effectiveness of the selected advertisements. For example, the application may continue to provide the user and the user's micronetwork with the selected advertisements until a particular lift over average is no longer achieved. The application may monitor the interactions of the user and the member within the user's micronetwork with the selected advertisements. Based on monitoring the interactions, the application may determine the number of members interacting with each of the advertisements. In some embodiments, each advertisements may have specific requirements attached to the advertisement (e.g., advertisement A is shown until less than 25% of members click on the advertisement, advertisement B is shown until less than 10% of members scroll over the advertisement, etc.). Advertisements that are not selected are less likely to be selected for display to the user and the members within the user's micronetwork, while advertisements that have a high click through rate are more likely to be selected for display.

Alternatively, the application may continue to provide the user with the selected advertisements until a predetermined time has elapsed.

It should be noted that each user has a micronetwork and the micronetwork may continually change. As a user changes (e.g., different interests, new interests, different members, new friends, etc.), the application may accommodate to the changes by rotating or adjusting the micronetwork associated with the user.

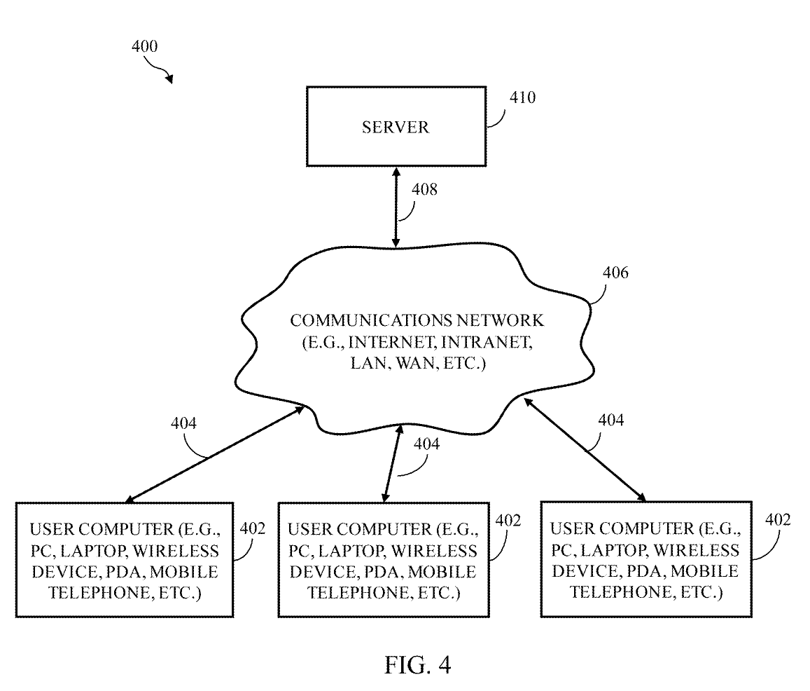

FIG. 4 is a generalized schematic diagram of a system 400 on which an interactive advertisement application may be implemented in accordance with some embodiments of the present invention. As illustrated, system 400 may include one or more user computers 402. User computers 402 may be local to each other or remote from each other. User computers 402 are connected by one or more communications links 404 to a communications network 406 that is linked via a communications link 408 to a server 410.

System 400 may include one or more servers 410. Server 410 may be any suitable server for providing access to the application, such as a processor, a computer, a data processing device, or a combination of such devices. Communications network 406 may be any suitable computer network including the Internet, an intranet, a wide-area network (“WAN”), a local-area network (“LAN”), a wireless network, a digital subscriber line (“DSL”) network, a frame relay network, an asynchronous transfer mode (“ATM”) network, a virtual private network (“VPN”), or any combination of any of such networks. Communications links 404 and 408 may be any communications links suitable for communicating data between user computers 402 and server 410, such as network links, dial-up links, wireless links, hard-wired links, any other suitable communications links, or a combination of such links. User computers 402 enable a user to access features of the application. User computers 402 may be personal computers, laptop computers, mainframe computers, dumb terminals, data displays, Internet browsers, personal digital assistants (“PDAs”), two-way pagers, wireless terminals, portable telephones, any other suitable access device, or any combination of such devices. User computers 402 and server 410 may be located at any suitable location. In one embodiment, user computers 402 and server 410 may be located within an organization. Alternatively, user computers 402 and server 410 may be distributed between multiple organizations.

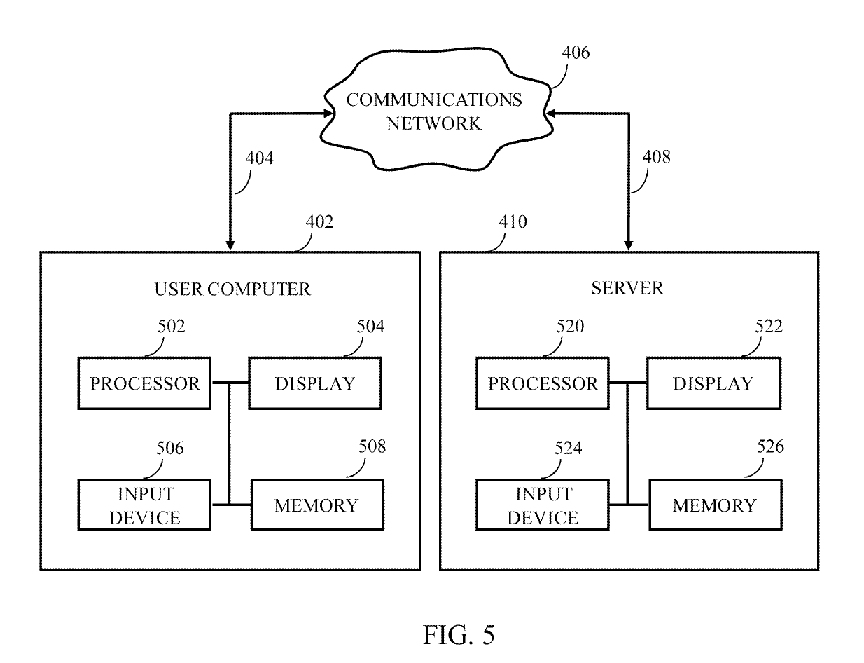

The server and one of the user computers, which are depicted in FIG. 4, are illustrated in more detail in FIG. 5. Referring to FIG. 5, user computer 402 may include processor 502, display 504, input device 506, and memory 508, which may be interconnected. In a preferred embodiment, memory 508 contains a storage device for storing a computer program for controlling processor 502.

Processor 502 uses the computer program to present on display 504 the application and the data received through communications link 404 and commands and values transmitted by a user of user computer 402. It should also be noted that data received through communications link 404 or any other communications links may be received from any suitable source, such as a social networking website (e.g., www.myspace.com) or any other suitable source. Input device 506 may be a computer keyboard, a cursor-controller, dial, switchbank, lever, or any other suitable input device as would be used by a designer of input systems or process control systems.

Server 410 may include processor 520, display 522, input device 524, and memory 526, which may be interconnected. In a preferred embodiment, memory 526 contains a storage device for storing data received through communications link 408 or through other links, and also receives commands and values transmitted by one or more users. The storage device further contains a server program for controlling processor 520.

In some embodiments, the application may include an application program interface (not shown), or alternatively, the application may be resident in the memory of user computer 402 or server 410. In another suitable embodiment, the only distribution to user computer 402 may be a graphical user interface (“GUI”) which allows a user to interact with the application resident at, for example, server 410.

In one particular embodiment, the application may include client-side software, hardware, or both. For example, the application may encompass one or more Web-pages or Web-page portions (e.g., via any suitable encoding, such as HyperText Markup Language (“HTML”), Dynamic HyperText Markup Language (“DHTML”), Extensible Markup Language (“XML”), JavaServer Pages (“JSP”), Active Server Pages (“ASP”), Cold Fusion, or any other suitable approaches).

In one particular embodiment, the application may be integrated with a social networking website. For example, the application may display advertisements on the social networking website when the user browses through various pages of the website (e.g., the myspace.com website). In response to the user viewing various pages on the website, the application may select another advertisement to be displayed on a portion of each page of the website.

It should be noted that the application may use cookies to match the user profiles to the author's computer. As advertisements are served on the pages of a social networking website, it may be initially unclear whether the person viewing a profile is the author of a page or a visitor. By using profile page visit frequency and session identifiers, the application stores this information in cookies. Within these cookies, the application sets the best current estimate of the user's unique identifier.

In some embodiments, at the time of an advertisement request, a packet of data is transmitted to the advertisement server (e.g., a server connected to the social networking website, a server controlled by the advertiser, a server controlled by the application, etc.). The packet may include, for example, cookie information containing the unique identifier. The unique identifier may be looked up in the database and a targeted advertisement may be selected and provided to the user of the social networking website.

Although the application is described herein as being implemented on a user computer and/or server, this is only illustrative. The application may be implemented on any suitable platform (e.g., a personal computer (“PC”), a mainframe computer, a dumb terminal, a data display, a two-way pager, a wireless terminal, a portable telephone, a portable computer, a palmtop computer, an H/PC, an automobile PC, a laptop computer, a cellular phone, a personal digital assistant (“PDA”), a combined cellular phone and PDA, etc.) to provide such features.

It will also be understood that the detailed description herein may be presented in terms of program procedures executed on a computer or network of computers. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine operations. Useful machines for performing the operation of the present invention include general purpose digital computers or similar devices.

The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

The system according to the invention may include a general purpose computer, or a specially programmed special purpose computer. The user may interact with the system via e.g., a personal computer or over PDA, e.g., the Internet, an Intranet, etc. Either of these may be implemented as a distributed computer system rather than a single computer. Similarly, the communications link may be a dedicated link, a modem over a POTS line, the Internet and/or any other method of communicating between computers and/or users. Moreover, the processing could be controlled by a software program on one or more computer systems or processors, or could even be partially or wholly implemented in hardware.

Although a single computer may be used, the system according to one or more embodiments of the invention is optionally suitably equipped with a multitude or combination of processors or storage devices. For example, the computer may be replaced by, or combined with, any suitable processing system operative in accordance with the concepts of embodiments of the present invention, including sophisticated calculators, hand held, laptop/notebook, mini, mainframe and super computers, as well as processing system network combinations of the same. Further, portions of the system may be provided in any appropriate electronic format, including, for example, provided over a communication line as electronic signals, provided on CD and/or DVD, provided on optical disk memory, etc.

Any presently available or future developed computer software language and/or hardware components can be employed in such embodiments of the present invention. For example, at least some of the functionality mentioned above could be implemented using Visual Basic, C, C++ or any assembly language appropriate in view of the processor being used. It could also be written in an object oriented and/or interpretive environment such as Java and transported to multiple destinations to various users.

Accordingly, an interactive advertisement application is provided.

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Although the present invention has been described and illustrated in the foregoing exemplary embodiments, it is understood that the present disclosure has been made only by way of example, and that numerous changes in the details of implementation of the invention may be made without departing from the spirit and scope of the invention.

What is claimed is:

1. A method for facilitating the transmission of advertisements to users, the method comprising:
presenting a user at a user computer with a publicly accessible website that includes user-generated social networking content over the Internet, wherein the user is authorized to access features and the user-generated social networking content associated with the publicly accessible website upon inputting user information;
in response to receiving user information from the user, displaying a webpage associated with the user;
displaying at least one advertisement on the webpage, wherein the at least one advertisement embeds an object in the user computer and wherein the object is used to obtain a unique identifier associated with the user;
using the object to construct a micronetwork of the members associated with the user, wherein the object obtains the unique identifier from each member that visits the webpage and the unique identifier from each member that establishes a relationship with the user;
using the object to monitor information relating to the user, wherein the information includes actions executed by the user;
retargeting advertisements for transmission to the user and the micronetwork based on information monitored by the object; and
transmitting at least one retargeted advertisement to the user and the micronetwork associated with the user, wherein the at least one retargeted advertisement is transmitted using the unique identifier associated with the user and the unique identifier associated with each member of the micronetwork.

2. The method of claim 1, wherein the object is embedded on the website and is transparent to the user and the members of the micronetwork.

3. The method of claim 1, wherein the association between the user and each member of the micronetwork is transparent to the user and each member of the micronetwork.

4. The method of claim 3, wherein the object captures at least one of: each unique identifier associated with the members that visit the webpage, the number of times the unique identifier associated with the member visits the webpage, the unique identifier associated with the member that selects the at least one advertisement while visiting the webpage, the unique identifier associated with the member that selects the at least one retargeted advertisement while visiting the webpage, the period of time that the member visits the webpage, visitation data in relation to webpages that the user visits, the unique identifier associated with the member that the user visits, the unique identifier associated with the member that the user establishes the relationship, websites that the user visits, and websites that the members of the micronetwork visit.

5. The method of claim 1, wherein the micronetwork includes one or more of: a first degree micronetwork, a second degree micronetwork, and a subset of members associated with the user.

6. The method of claim 1, wherein the publicly accessible website is a social networking website.

7. The method of claim 1, further comprising:
storing the information that is monitored by the object;
analyzing the stored information; and
assigning the user to a particular micronetwork based on the analysis.

8. The method of claim 1, wherein the unique identifier associated with the user and the unique identifiers associated with the members of the micronetwork are obtained by extraction from Uniform Resource Locator (URL) links to webpages of the publicly accessible website.

9. The method of claim 1, further comprising monitoring effectiveness of the at least one retargeted advertisement.

10. The method of claim 9, further comprising determining a rate of which the at least one retargeted advertisement is selected by the user and the members of the micronetwork that the at least one retargeted advertisement is transmitted.

11. The method of claim 10, further comprising removing the at least one retargeted advertisement in response to the rate being less than a preset response rate.

12. A system for facilitating the transmission of advertisements to users, the system comprising:
a processor that:
presents a user at a user computer with a publicly accessible website that includes user-generated social networking content over the Internet, wherein the user is authorized to access features and the user-generated social networking content associated with the publicly accessible website upon inputting user information;
in response to receiving user information from the user, displays a webpage associated with the user;
displays at least one advertisement on the webpage, wherein the at least one advertisement embeds an object in the user computer and wherein the object is used to obtain a unique identifier associated with the user;
uses the object to construct a micronetwork of the members associated with the user, wherein the object obtains the unique identifier from each member that visits the webpage and the unique identifier from each member that establishes a relationship with the user;
uses the object to monitor information relating to the user, wherein the information includes actions executed by the user;
retargets advertisements for transmission to the user and the micronetwork based on information monitored by the object; and
transmits at least one retargeted advertisement to the user and the micronetwork associated with the user, wherein the at least one retargeted advertisement is transmitted using the unique identifier associated with the user and the unique identifier associated with each member of the micronetwork.

13. The system of claim 12, wherein the processor is further configured embed the object on the website such that the object is transparent to the user and the members of the micronetwork.

14. The system of claim 12, wherein the association between the user and each member of the micronetwork is transparent to the user and each member of the micronetwork.

15. The system of claim 14, wherein the processor is further configured to use the object to capture at least one of: each unique identifier associated with the members that visit the webpage, the number of times the unique identifier associated with the member visits the webpage, the unique identifier associated with the member that selects the at least one advertisement while visiting the webpage, the unique identifier associated with the member that selects the at least one retargeted advertisement while visiting the webpage, the period of time that the member visits the webpage, visitation data in relation to webpages that the user visits, the unique identifier associated with the member that the user visits, the unique identifier associated with the member that the user establishes the relationship, websites that the user visits, and websites that the members of the micronetwork visit.

16. The system of claim 12, wherein the micronetwork includes one or more of: a first degree micronetwork, a second degree micronetwork, and a subset of members associated with the user.

17. The system of claim 12, wherein the publicly accessible website is a social networking website.

18. The system of claim 12, wherein the processor is further configured to:
store the information that is monitored by the object;
analyze the stored information; and
assign the user to a particular micronetwork based on the analysis.

19. The system of claim 12, wherein the processor is further configured to obtain the unique identifier associated with the user and the unique identifiers associated with the members of the micronetwork by extraction from Uniform Resource Locator (URL) links to webpages of the publicly accessible website.

20. The system of claim 12, wherein the processor is further configured to monitor effectiveness of the at least one retargeted advertisement.

21. The system of claim 20, wherein the processor is further configured to determine a rate of which the at least one retargeted advertisement is selected by the user and the members of the micronetwork that the at least one retargeted advertisement is transmitted.

22. The system of claim 21, wherein the processor is further configured to remove the at least one retargeted advertisement in response to the rate being less than a preset response rate.
